(19) United States
(12) Patent Application Publication
(10) Pub. No.: US 2023/0387688 A1
(43) Pub. Date: Nov. 30, 2023

(54) AUXILIARY SYSTEM FOR ELECTRICAL ENERGY DISTRIBUTION BASED ON BIO-GENERATOR SETS WITH TESLA COIL FEEDBACK

(71) Applicant: Aloysio RODRIGUES DA CUNHA, Belo Horizonte (BR)

(72) Inventors: Aloysio RODRIGUES DA CUNHA, Belo horizonte (BR); Anderson LUIZ TOME PEREIRA BARBOSA, Belo horizonte (BR)

(73) Assignee: Aloysio RODRIGUES DA CUNHA, Belo Horizonte (BR)

(21) Appl. No.: 18/245,901

(22) PCT Filed: Dec. 9, 2020
(86) PCT No.: PCT/BR2020/050525

§ 371 Date: Mar. 20, 2023

(30) Foreign Application Priority Data
Sep. 29, 2020 (BR) 10 2020 019897 1

(51) Int. Cl. H02J 3/01; H02J 3/24

(52) U.S. Cl. CPC H02J 3/01; H02J 2300/10; H02J 3/241

(57) ABSTRACT

The present technology, which is part of the field of electrical systems, more specifically electromechanical generators, establishes an interactive system for the permanent use of motor generators that can be implemented in residential areas or in small industries. The minimum components required are a generator (motor generator), a 250 A current transformer, a Tesla coil responsible for filtering harmonics, a switching system via a booster composed of transistors and relays to control the impedances and frequency of the network, and an inverter to ensure the correct frequency.

### BACKGROUND OF THE INVENTION

The present invention patent refers to an auxiliary system for the distribution of electrical energy, applied to bio-generators powered by Tesla coils feedback. Inserted in the technical field of electrical systems, more specifically in devices for energy treatment, conditioning and optimization, this technology enables a reduction of costs and environmental impacts arising from the electrical distribution process. It establishes an interactive system for the permanent use of motor generators that can be implemented in residential areas or in small industries, with a maximum operating load of 420 KW.

### DESCRIPTION OF RELATED ART

Electric generators are devices that can convert different forms of energy, such as mechanical, chemical, and solar energy, into electrical. The most common operating principle among generators is electromagnetic induction. This process occurs when a set of conductive coils, arranged inside the generators, are placed between magnets so that the rotation of these coils can produce a large amount of electric current, used to power the most varied types of electrical circuits.

Motor generator is a term used for electric generators that are mainly used for combustion engines. Power generators, or motor generators, are indispensable machines in places where there is no electricity supply or there is great instability, helping in the continuity of the activities being carried out even if there are shortages.

In addition, electric generators can operate in residential areas as a great alternative during emergencies, when electricity is needed but scarce.

Although motor generators are associated with the use of fossil fuels, it is possible to use alternative renewable sources, such as ethanol, biodiesel, molecular hydrogen, and even photovoltaic systems. Some of the advantages of using these sources involve lower production of noise and harmful gases, independence of limited resources, and greater thermal efficiency.

The efficiency of a generator can be calculated by the ratio between the mechanical power supplied to the generator and the power generated by the device. A diesel generator has an average efficiency ranging from 36% to 41%, using fuel with a calorific value of 10.50 Kcal/kg.

A gas generator has an average efficiency of 34% to 38%, using natural gas with a calorific value of 9,400 Kcal/m3 for each Kw.h of energy produced, while photovoltaic generators still have an average efficiency that is around 9% to 16%.

Several technologies aim to increase the efficiency of generators, using mainly renewable resources. One of the possible branches, although still incipient, is the feedback of the system using a Tesla coil. The patents below describe the use of this coil in some generators, despite showcasing mechanisms different from the claimed matter.

RO131003A2 describes a Tesla coil electric generator with no moving parts. This technology consists of a set of cylindrical polarized magnets at one end, along with a ferromagnetic bar, with a small solenoid wrap on the opposite side.

WO2020082965A1 describes a gas turbine generator comprising a rotating shaft, a first radial bearing, a motor, a second radial bearing, a Tesla compressor, a combustion chamber, a Tesla Turbine, and a third radial bearing. This generator has a rotor system supported by non-contact bearings, improving the overall efficiency of the gas turbine generator.

### SUMMARY OF THE INVENTION

Generator systems have been used as temporary solutions during emergencies or unforeseen circumstances. The present invention aims to use an interactive system that allows the permanent use of this technology, which can be installed in residential systems or small industries. This can be accomplished by filtering and harmonizing the generated output with the electrical grid. The minimum components required are a generator (motor generator), a 250 A current transformer, a Tesla coil responsible for filtering harmonics, a switching system via a booster composed of transistors and relays to control the impedances and frequency of the network, and an inverter to ensure the correct frequency.

### BRIEF DESCRIPTION OF DRAWINGS

Its details can better be understood through the following detailed description in line with the attached figures, where:

FIG. 1 represents an activation controller for the power distribution support system, which will filter the incoming load and determine the load value through the controller (CLR).

FIG. 2 represents the closed-loop functional structure of the system's operating model.

FIG. 3 depicts the pre-charging model of the system-feed assembly.

FIG. 4 identifies the variation and noise in the stabilization process, denoting the stabilization and inference point of the internal signal in the distribution circuit, applied to a load.

FIG. 5 refers to an input and output signal test.

FIG. 6 presents the cross-current synapse.

FIG. 7 depicts the power variation according to the input control.

### DETAILED DESCRIPTION OF THE INVENTION

The present invention can be conceived as an auxiliary system for electrical power distribution, enabling a reduction in costs and environmental impacts of the electrical distribution process.

The system is composed of a generator (motor generator), a 250 A current transformer, which is a derivative filter, a Tesla coil responsible for filtering the harmonics, a switching system with a booster composed of transistors and relays for controlling the impedances and the network frequency, and an inverter to ensure the correct frequency.

The reduction in environmental impact is accomplished by this support model, which reduces the effects of anomalous electromagnetic fields originating from the distribution process, reduces the number of materials needed, increases the lifespan of the devices that compose the network, and reduces the hysteresis effects.

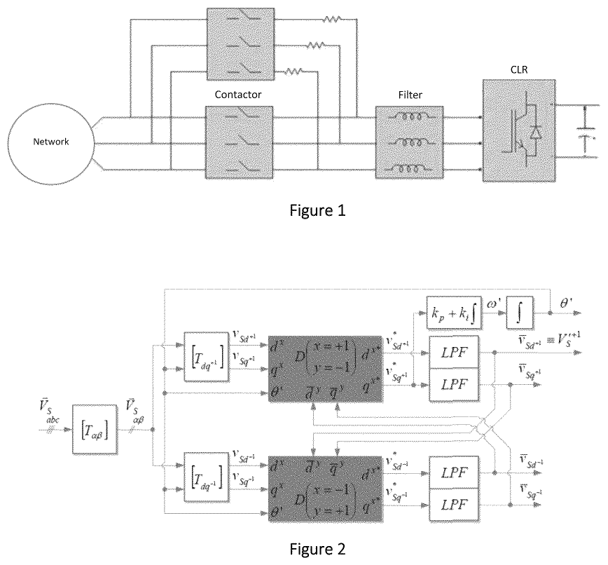

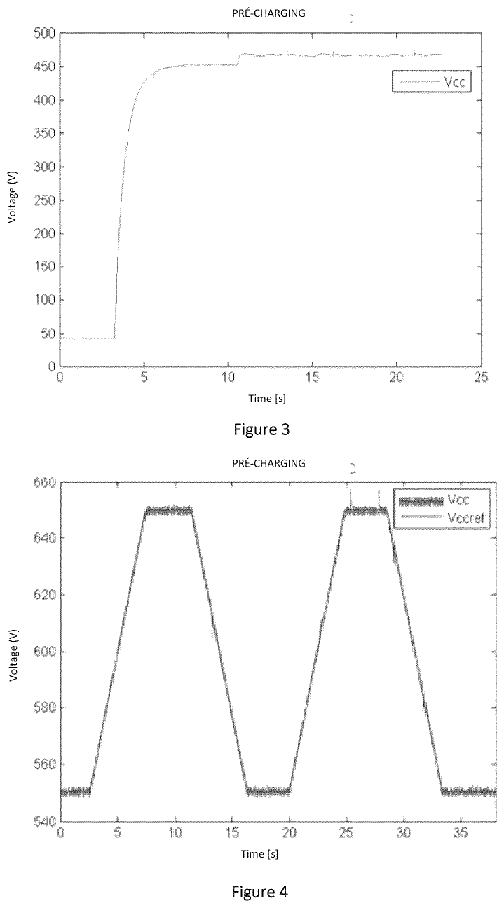

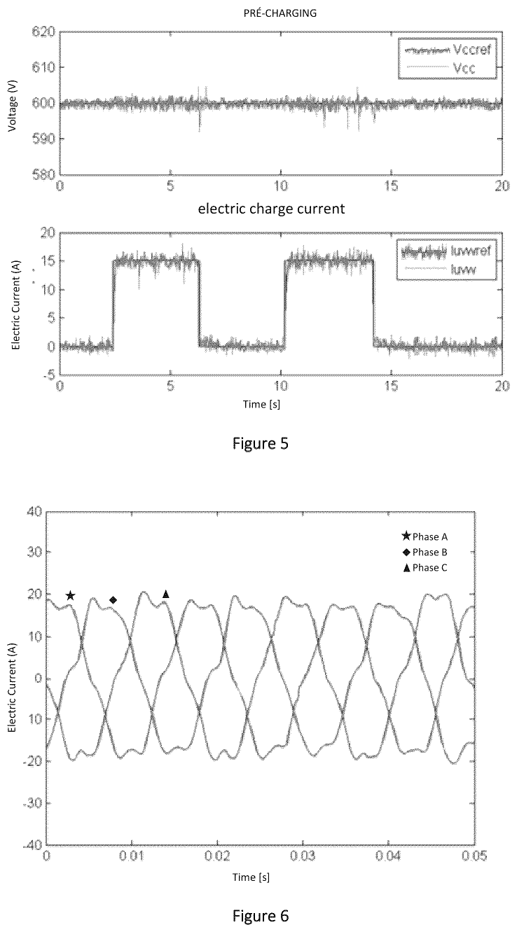

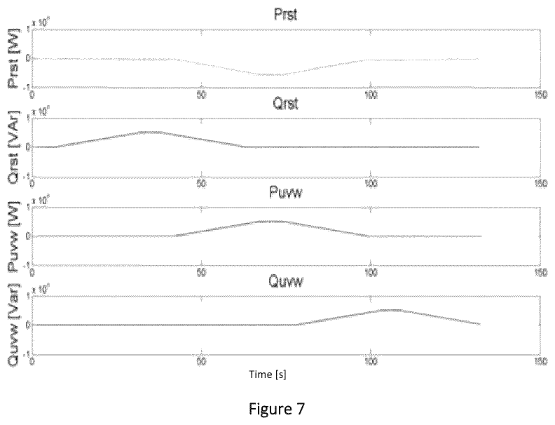

The system's charge controller uses pulse-width vector modulation, or Space Vector Modulation, which allows the connection of a conversion system to the power grid. From the input voltage, the positive and negative sequence components are extracted. The angle of the grid voltage is calculated through the positive-sequence component, obtained after the coupling between the synchronous reference axis signals, represented by FIG. 1.

When it receives the signal, the system directs it to an integrator, whose function is to assemble the load balance in the two differential systems: the filtering and the stabilization system. Consequently, the signal is transmitted to two Lagrangian control modules, whose main purpose is to distribute the signal to the redistribution system (Tesla coil), which will receive the signal clean, amplify it, and redistribute it again.

The control module has a magnetic filter, with a capacitive switching system that makes the phase correction and conditioning of the impedance and internal voltage, and an inverter that allows it to transfer the output to the Tesla coil.

The concept of using a bio-motor generator is based on the reduction of environmental impacts originating from the various sources exposed above, and on the economy provided using this technology, especially in small areas or at locations with difficult access to conventional methods of electricity distribution.

As presented in the description of FIG. 2, the closed loop system is based on, among other aspects, energy reconditioning and optimization through the valorization of the efficiency of the electrical signal. It will, in turn, ensure a power matching between the intermediary system (Tesla Coil Feedback Bio-motor Generator) and the supplying grid.

This technology establishes an interactive system for the permanent use of these generators (motor generators), which can be used in various applications, provided that the maximum operating load does not exceed 420 KW. Within the range of the system, a significant number of Tesla coil power outlets can be used, with their application transforming capacity.

### FIELDS OF APPLICATION

The scope of this report emphasizes the numerous uses of the Tesla coil in a wide variety of applications, specifically when the Tesla coil is used in an UNINTERRUPTED POWER SUPPLY SYSTEM or UPS (Uninterruptible Power Supply), performing a feedback process. Again, at this point, several applications become available, especially when we consider all the energy sources that can be magnified using Tesla coils. When power sources are not available, motor generators can be installed.

Another scenario occurs when the motor generators are replaced by a battery bank. These batteries can also be replaced by the UPS when the motor generator becomes a Tesla-Generator, i.e., powered by feedback.

What is claimed is:

1. AUXILIARY SYSTEM FOR ELECTRICAL ENERGY DISTRIBUTION BASED ON BIO-GENERATOR SETS WITH TESLA COIL FEEDBACK, it establishes an interactive system for the permanent use of motor generators that can be implemented in residential areas or in small industries, with a maximum operating load of 420 KW, characterized by a system that comprises a generator (motor generator), a 250 a current transformer, which is a derivative filter, a tesla coil responsible for filtering the harmonics, a switching system with a booster composed of transistors and relays for controlling the impedances and the network frequency, and an inverter to ensure the correct frequency.
